(19) United States
(12) Patent Application Publication
(10) Pub. No.: US 2008/0059874 A1
(43) Pub. Date: Mar. 6, 2008

(54) FACILITATED GENERATION OF HIGHLY PERSONALIZED COMMUNICATIONS

(76) Inventor: Lawrence D. Spencer, Marlborough, MA (US)

Correspondence Address: SHEEHAN PHINNEY BASS & GREEN, PA;c/o PETER NIEVES, 1000 ELM STREET, MANCHESTER, NH, 03105-3701, US

(21) Appl. No.: 11/848,873

(22) Filed: Aug. 31, 2007

Related U.S. Application Data
(60) Provisional application No. 60/824,143, filed on Aug. 31, 2006.

(51) Int. Cl. G06F 15/00

(52) U.S. Cl. 715/235

(57) ABSTRACT

A method is disclosed for facilitating the generation of highly personalized communications, such as newsletters, for a specific recipient. The communication's content is determined by and format is arranged according to software-controlled rules called “Content Directives”. Information about the recipient is recorded in a database and is reviewed to determine such things as whether a given recipient is to receive a given communication and what communication content should be sent to each recipient. Communications may be sent physically or electronically, and according to a flexible schedule determined either by the sender or by recipient.

### FIELD OF THE INVENTION

The invention relates generally to the generation of communications. More particularly the invention relates to automatically generating communications, such as newsletters that include content highly personalized according to an intended recipient.

### BACKGROUND

Many businesses use newsletters as a marketing tool, sent to customers and potential customers, to generate interest in their products and potentially result in sales. Many of these newsletters are never read, and rarely accomplish their marketing goal.

While attempts have been made to add a personal touch to newsletters by including the recipient's name or such, all such attempts have lacked the depth and specificity to avoid appearing as mere “form letters.” Such efforts have often backfired on the businesses that send them, by insulting the intelligence of the recipients they were intended to attract.

For a marketing newsletter to be truly effective and meet its intended goals, there is needed a system and method for truly personalizing individual newsletters to a depth and specificity that will give even the most jaded recipient the feeling that the newsletter was written specifically for him, with the most personal knowledge of him, and that its information was not merely pulled by a computer from a database. The recipient must be made to feel that the sender was a person who knows him, and not a machine or computer.

### SUMMARY

This disclosure presents a cost efficient system and process, as only one exemplary embodiment of the present invention, for generating with minimal effort highly personalized communications targeted to individual recipients.

In one aspect, a process for facilitating the generation of highly personalized communications may include obtaining information related to a number of recipients and at least one sending business and automatically selecting at least one of the recipients according to a scheduling procedure. The process may also include automatically selecting Content Directives from a content repository for the selected at least one recipient and automatically producing Content according to the Content Directives. Depending on the nature of each Content Directive, it may produce Content that is personalized to the recipient or the sending business.

In some embodiments, automatically personalizing may include using additional data from one or more other repositories, such as a recipient repository and a business repository. One or more of the repositories may be electronic repositories.

In another aspect of the invention, a system for generating highly personalized communications for at least one intended recipient may include a content repository containing instructions for producing personalized Content, a schedule repository containing schedule information according to which the personalized Content should be produced, and a content producer producing the personalized Content for the at least one intended recipient according to the schedule information and instructions. The instructions in the Content repository may be parameters that get fed to the system's content-producing software, which contains the instructions in the form of software code.

The schedule information and instructions may be parameters given to a Content-producing function of the system's software. Thus, this Content-producing function may effectively contain the instructions in code, rather than a repository.

In yet another aspect of the invention, a system for producing and delivering personalized Content may include a recipient repository containing information relating to possible recipients of the personalized Content. The system may also include a business repository containing information relating to the business entity or entities intending to send the personalized Content; a content repository containing Content Directives, each of which includes instructions for producing some or all of one or more issues of personalized Content; and a schedule repository containing schedules according to which the personalized Content is created. A content producer creates personalized Content for each recipient according to a schedule contained within the schedule repository and instructions contained in the content repository. One or more of the recipient, business, content, and schedule repositories may be an electronic repository, such as an electronic database.

In some embodiments, the system may also include software for maintaining one or more of the repositories. In some embodiments, the Content Directives may include instructions directing the content producer to extract data from one or more of the recipient repository, the business repository, any other electronic repository, or any combination thereof.

In some embodiments, Nested Content Directives may be provided. Nesting occurs when one Content Directive (the parent Content Directive) contains instructions to draw upon the output of another (the Nested Content Directive). The Nested Content Directives may nest to any desirable depth, constrained only by the physical limits of the computing device on which the content producer executes.

In some embodiments, the content repository may include one or more Content Directives that can be used by more than one sending business, as well as one or more Content Directives having use that is restricted to one sending business. The Schedule Repository may allow any given recipient's schedule to be set by a default that applies to the entire business that is sending him personalized Content, or set to apply to said recipient only.

The Content Directives may be stored in XML form, either in whole or in part. Output according to the Content Directives may also be provided in XML form. The personalized Content may be delivered in printed form, electronically via facsimile or e-mail, or any combination thereof The content producer may be run by a single business entity, in service of all the sending businesses that are in the business repository. The personalized Content may include newsletters, fund-raising letters and the like.

Alternatively or in addition, the personalized Content may encourage the recipients to take some action, such as applying for membership in or admission to the sending business. The sending business may include as part of the personalized Content one or more personal messages to a selected recipient, or to a group of recipients.

When used as a business model, the system may include sharing Content between the business' Clients, including Content that they create. The business owner may control the selection of Content. Newsletters may be delivered either electronically or on paper.

Another aspect is a method or business model for facilitating the generation of highly personalized communications beyond just newsletters. The method may start with the general format of a newsletter, for example, for a specific recipient. In reviewing the format for the newsletter, the software may recognize rules (i.e., Content Directives) and the calling of specific Content. If a rule, information about the recipient may be reviewed to determine which article would be best for that recipient. As an example, if information gathered about the recipient shows that she is an owner of an old car, an article on a new car may be selected.

Within a Content Directive that specifies an article for a recipient there may be one or more Nested Content Directives. The top-level (article) Content Directive may ask for information specific to the recipient of the newsletter. As an example, if the article is on automobiles, the article's main Content Directive may specify a Nested Content Directive in a specific spot of the article to supply the model and year of the recipient's car. This Nested Content Directive may tell the content producer to obtain the information from a recipient repository. As a further example, if the article Content Directive wishes to suggest a new car to the recipient, it may specify a Nested Content Directive to choose a car based on business rules. That Nested Content Directive would specify further Nested Content Directives to obtain information about the car suggested by the business rules. Thus, if the recipient owns an old Ford Mustang, the suggestion for model and year of a car may be for a 2008 Ford Mustang, due to knowledge of the recipient having an old Ford Mustang. The newsletter or other form of communication may be personalized automatically.

Content may also include mathematical or character-manipulating expressions for filling in of information within the article. As an example, the newsletter may be on automobiles, and the recipient's car may be known to be an old Ford Mustang that results in only 12 miles per gallon. A mathematical expression may be used and the information regarding the recipient's car may be used to provide a summary of the cost for gas to the recipient of the newsletter if they continue to use their present vehicle.

In summary, we have the marrying of the recipient's personal data with the business's data to help the sending business win referrals and increase Customer loyalty. And this can automatically be prepared and sent in accordance with a set of schedules that can override each other.

### BRIEF DESCRIPTION OF THE DRAWINGS

Many aspects and further advantages of this invention may be better understood by referring to the following description of several exemplary embodiments, in conjunction with the accompanying drawings. The components in the drawings are not necessarily to scale, and emphasis is placed upon clearly illustrating the exemplary embodiments and the principles of the invention. In the drawings, like reference numerals designate corresponding parts throughout the several views.

FIG. 1A is an image of exemplary personal database fields including personal information about a first Customer.

FIG. 1B is an image of a first exemplary newsletter prepared according to the principles of the present invention with the personal data of the first Customer of FIG. 1A.

FIG. 2A is an image of the personal database fields of FIG. 1A including personal information about a second Customer.

FIG. 2B is an image of a second exemplary newsletter prepared according to the principles of the present invention with the personal data of the second Customer of FIG. 2A.

FIG. 3A is an image of the personal database fields of FIG. 1A including personal information about a third Customer.

FIG. 3B is an image of a third exemplary newsletter prepared according to the principles of the present invention with the personal data of the third Customer of FIG. 3A.

FIG. 4A is an image of the personal database fields of FIG. 1A including personal information about a fourth Customer.

FIG. 4B is an image of a fourth exemplary newsletter prepared according to the principles of the present invention with the personal data of the fourth Customer of FIG. 4A.

FIG. 5 is a block diagram of an exemplary system for producing and delivering personalized Content according to a first embodiment of the invention.

FIG. 6 is a flow diagram of an exemplary process for producing and delivering personalized Content according to the embodiment of FIG. 5.

FIG. 7 is an exemplary table of articles according to the embodiment of FIG. 5.

FIG. 8 is an exemplary layout Content Directive for a letter according to the embodiment of FIG. 5.

FIG. 9 is an exemplary Content Directive that could nest in the layout Content Directive of FIG. 8, according to the embodiment of FIG. 5.

FIG. 10 is an exemplary Conditional Content Directive that could nest in the letter-layout Content Directive of FIG. 8, according to the embodiment of FIG. 5.

FIG. 11 is an exemplary Letter Content Directive that could nest in the Conditional Content Directive of FIG. 10, according to the embodiment of FIG. 5.

FIG. 12 is an exemplary child type Directive that could nest in the letter Content Directive of FIG. 11, according to the embodiment of FIG. 5.

FIG. 13 is an exemplary Content Directive that could nest in the child type Content Directive of FIG. 12, according to the embodiment of FIG. 5.

FIG. 14 is an exemplary content manager according to the embodiment of FIG. 5.

FIG. 15 is a flowchart illustrating steps performed to produce a newsletter within the system.

### DEFINITIONS

The following definitions are useful for interpretating terms applied to features of the embodiments disclosed herein, and are meant only to define elements within the disclosure. No limitations on terms used within the claims are intended, or should be derived, thereby. Terms used within the appended claims should only be limited by their customary meanings within the applicable arts.

As used within this disclosure, “Content” will refer to anything that is put into a newsletter or other communication.

As used within this disclosure, “Constant Content” is Content that does not change. For example, within an article, there could be a sentence that never changes; that would be Constant Content.

As used within this disclosure, a “Customer” is an end-user of the system, such as a recipient of a personalized newsletter or a subscriber to a magazine.

As used within this disclosure, a “Client” is a customer to the System Creator who is responsible for the Customer-specific data entered into the system and, from the Customer's point of view, is the sender of messages, newsletters, emails, publications, and other matters that are sent out by the system. Depending on how the invention is embodied, either the Client or the System Creator may run the system that produces and sends the communications.

As used within this disclosure, a “System Creator” or “Creator” is the entity that creates the software that drives the system and the entity that offers the software to Clients, oversees software use in some embodiments, and masters the website where the software run.

As used within this disclosure, “Variable Content” is data that might vary with the recipient, with the Client, with the price of gasoline, etc. Typically, Variable Content will come from database fields. Variable Content could also come from other websites. For example, a Realtor's newsletter might include students' standardized testing scores in the recipient's town, and those scores might come from a public website. Other sources are possible as well.

As used within this disclosure, a “Class” is a body of software designed to fulfill the instructions in a particular type of Content Directive, and an “Object” is an instance of a Class, possibly made different from other instances of the Class by specification of parameter(s) when the Object is constructed.

As used within this disclosure, a “Content Directive” is a set of instructions for generating Content. These instructions are fulfilled by an executing body of computer code of a Class designed for that type of Content Directive. The computer code (the “Object”) is possibly governed by one or more parameters, and produces formatted newsletter Content. Here are some examples, starting with the most trivial.
Insert the sentence, “We hope to see you soon.”
If the person is male, insert Article 1; otherwise insert Article 2.
Within Article 1: If the person has children, insert, “And bring your kids, too!”
Within Article 2: If the person has a spouse, insert, “And bring <spouse's name>, too!” (where <Spouse's name> is to be filled in from a database field, in mail-merge fashion.)

As used within this disclosure, a “Layout” consists of instructions for arranging Content in a newsletter.

As used within this disclosure, “Fulfilling a Content Directive” means gathering the data required by the Content Directive.

As used within this disclosure, a “Nested Content Directive” is a Content Directive that aids in fulfilling another Content Directive.

### DETAILED DESCRIPTION OF THE INVENTION

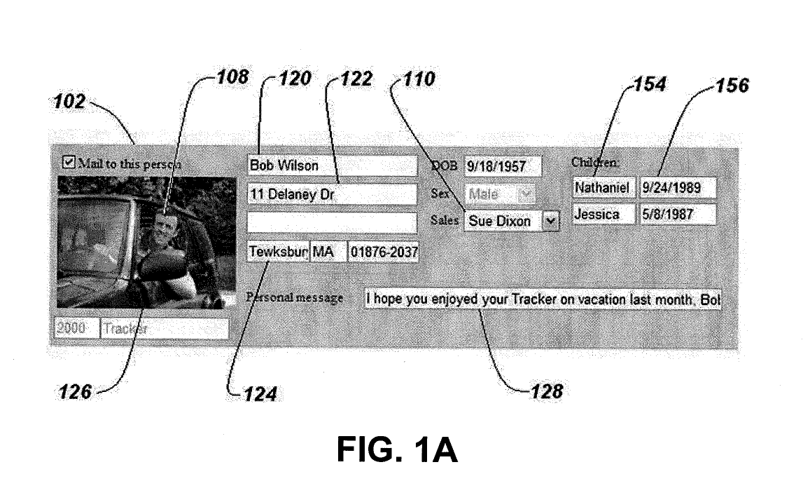

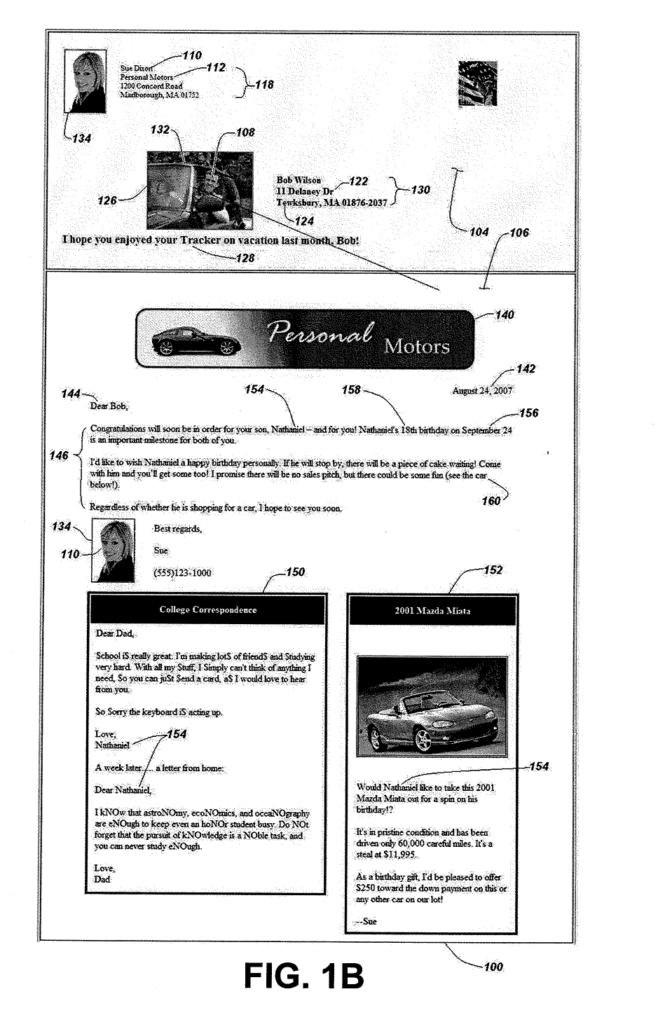

Referring first to FIGS. 1A and 1B, there is shown a newsletter 100 (FIG. 1B) and a collection of personal database fields 102 (FIG. 1A), according to a first exemplary embodiment of the invention. Newsletter 100 has a cover portion 104 and a letter portion 106. Newsletter 100 has been prepared for sending to Customer Bob Wilson 108, by car salesperson Sue Dixon 110 of company Personal Motors 112.

For each Client, the system includes a data-collection form equivalent to 102, which is adapted for the input of information such as the Customer's name 120, street address 122, town 124, a photo 126 of the Customer in some relevant scene, the name of their salesperson 110 at the company, and other information. A personal message 128 may also be recorded.

On cover 104, the Customer's name, street address 122, and other information is automatically inserted into the personalized destination address 130 from database fields shown on form 102. Photo 126 is taken from database field 108 and inserted adjacent destination address 130, showing Customer 108 in a vehicle 132 he had previously purchased from salesperson 110, which photograph is taken at the time of the purchase.

Adjacent to the personalized return address 118 of salesperson 110 on cover 104 is a photograph 134 of salesperson 110 taken from the salesperson's database field stored within the system.

Letter portion 106 includes masthead 140 taken from a masthead database within the system, the current date 142 taken from a date program within the system that looks up or calculates the current date, a salutation 144 including the title and first name of Customer 108 derived from data on data-entry form 102, a message 146 specified by a Content Directive ‘A’ that was nested in a Content Directive ‘B’ whose job was to choose an appropriate message based on the data shown on data-entry form 102. Likewise, inserts 150 and 152 are the results of Content Directives that were chosen by parent Content Directives based on information from data-entry form 102. Within the message and inserts is “nested” Variable Content that is chosen or calculated from data on form 102. For instance, in this case, the name 154 “Nathaniel” and birth date 156 “September 24” of the son of Customer 108 are taken from fields on form 102, while the age 158 “18^{th} birthday” is calculated within the system using information from form 102, and the insert reference 160 and related insert 152 are chosen based on the age of the son.

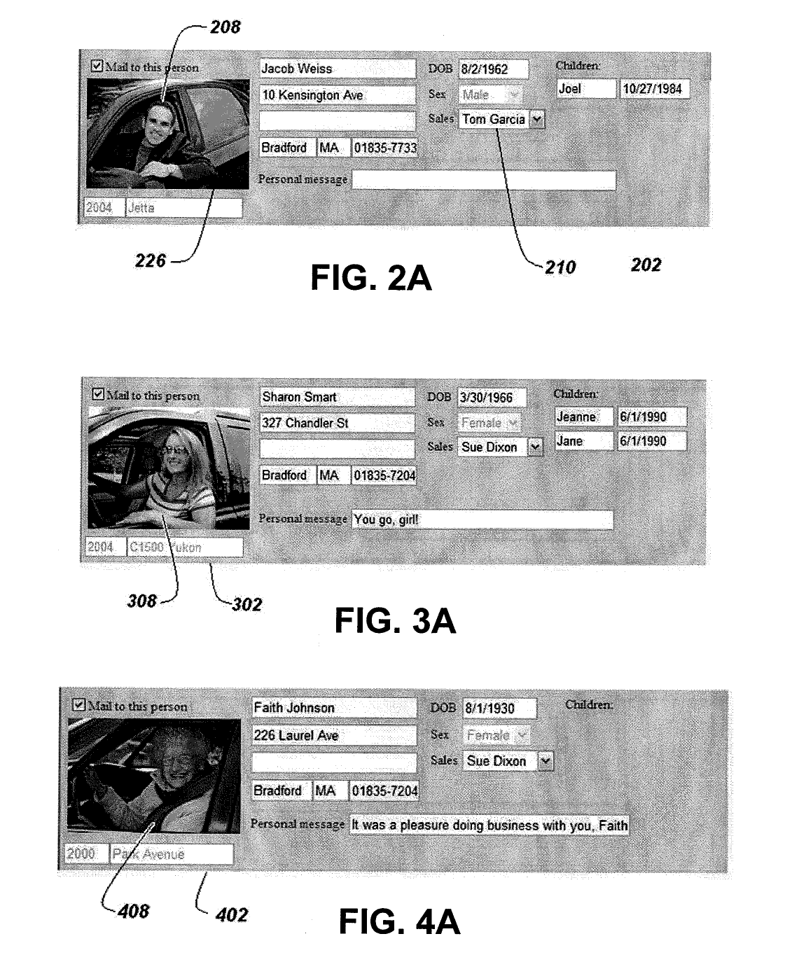

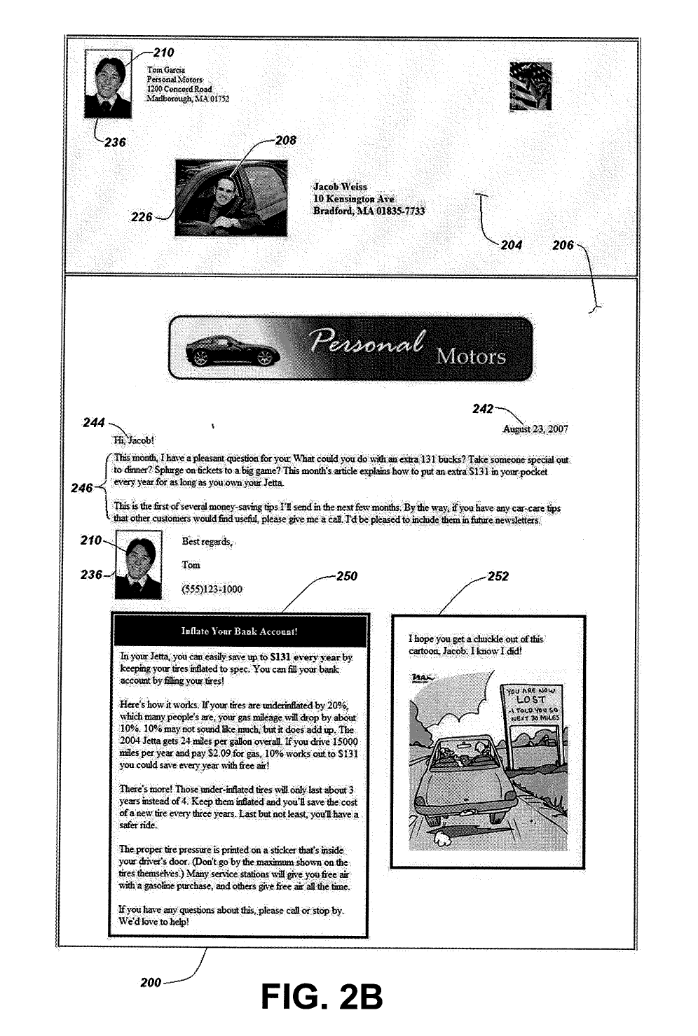

Shown in FIGS. 2A and 2B are a second exemplary newsletter 200 (FIG. 2B) and personal data-entry form 202 (FIG. 2A). As in the first example, newsletter 200 has a cover portion 204 and a letter portion 206. It will be observed that newsletter 200 has been automatically prepared and personalized for sending to Customer Jacob Weiss 208, by car salesperson Tom Garcia 210, and among other differences includes an appropriate and automatically generated date 242, salutation 244, message 246, Customer photo 226, salesperson photo 236, and inserts 250 and 252, which inserts are similarly modified with Nested Content specific to Customer 208.

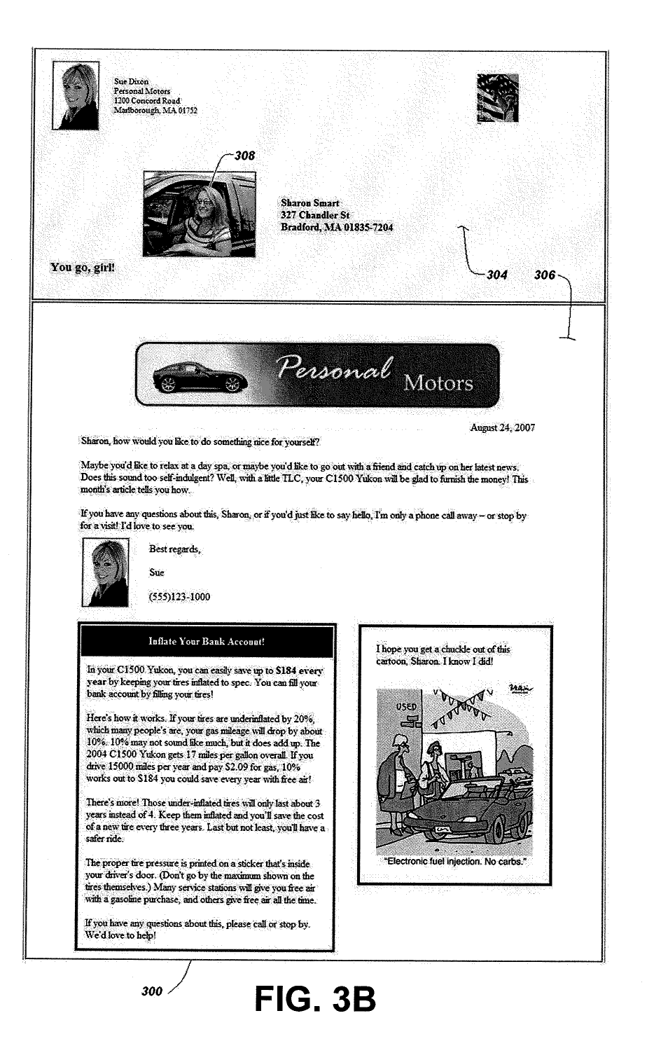

Shown in FIGS. 3A and 3B are a third exemplary newsletter 300 (FIG. 3B) and personal data-entry form 302 (FIG. 3A). As in the first example, newsletter 300 has a cover portion 304 and a letter portion 306 which have been personalized differently, although through similar processes, for Customer Sharon Smart 308.

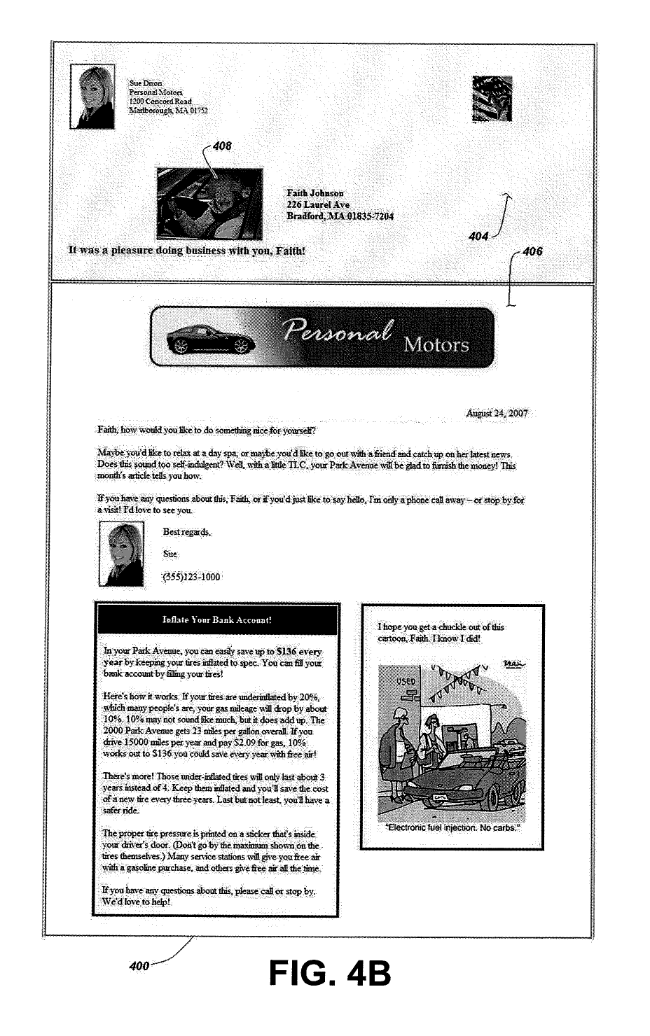

Shown in FIGS. 4A and 4B are a fourth exemplary newsletter 400 (FIG. 4B) and personal data-entry form 402 (FIG. 4A). As in the first example, newsletter 400 has a cover portion 404 and a letter portion 406, which have been personalized differently, although through similar processes, for Customer Faith Johnson 408.

So it should be appreciated that not only do the above-disclosed newsletters contain Customer-specific information, but by comparison of the several examples, that the Content of each section of the newsletters may be chosen or altered according to Customer-specific attributes, that the Content of the chosen or altered Content may be further chosen or altered according to Customer-specific attributes, that the Content of the further chosen or altered Content of the chosen or altered Content may be even further chosen or altered according to Customer-specific attributes, and so on and so on to any desired level.

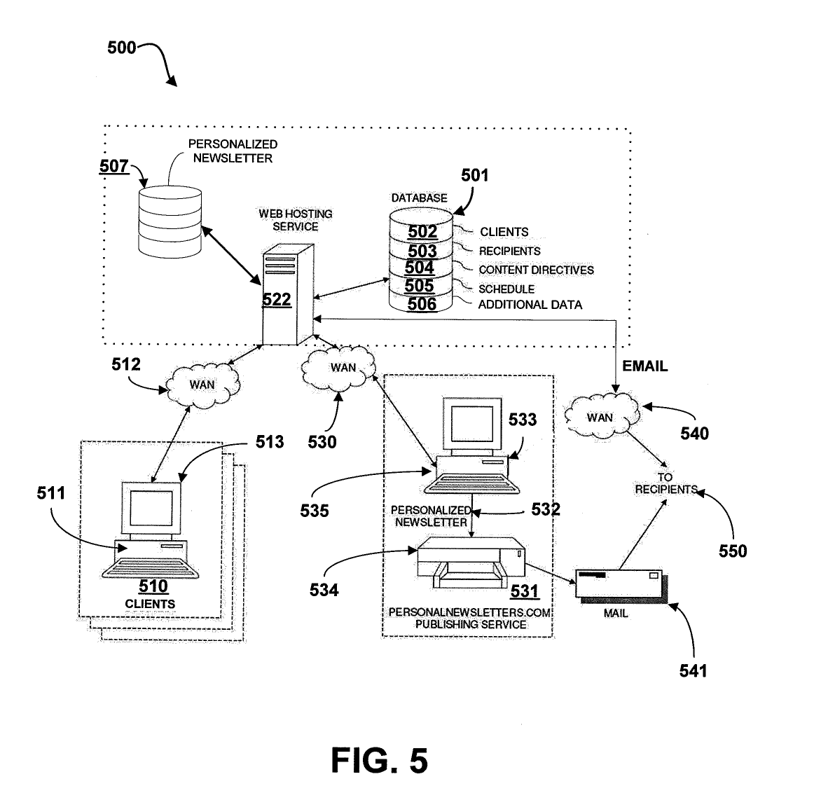

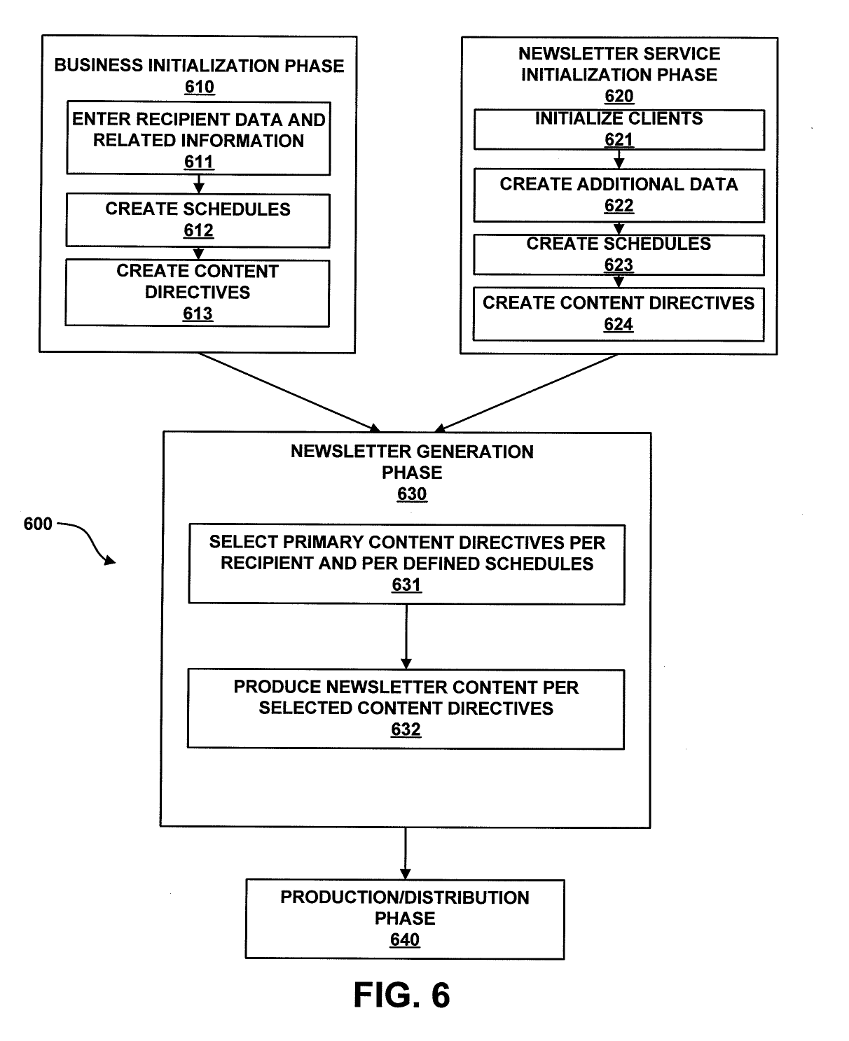

The process for producing such automatically personalized newsletters is best understood with reference to system 500 of FIG. 5, and the accompanying process flow diagram 600 shown in FIG. 6. System 500 has enabled the appropriate person at the business, such as a salesperson, to set up such highly personalized communication programs for each of his Customers in a matter of minutes by merely specifying the Content Directives, setting up a schedule, and inputting the above described Customer information into a Client specific data-entry form. The salesperson may simply enter the Customers' demographic information, upload photos, and create relevant personal messages. Alternatively, the data-entry form could accept input about a Customer's purchasing history, the Customer's personal interests, other Customers with which the Customer is acquainted, the high school from which the Customer graduated and year of graduation, links to the database fields of other Customers and family members, and other information. The software of system 500 organizes the newsletter, choosing appropriate Content, calculating and creating appropriate Nested Content, and sending out a useful, relevant newsletter to every one or a chosen some of the salesperson's Customers on a schedule the salesperson or his company selects or has pre-selected. Even the schedule may be altered in some Customer-specific manner, such as according to a Customer's pre-stated preference. And the method of delivery, such as by mail, by email, or even by an automated phone message, may be altered according to a Customer's pre-stated preferences.

In the embodiment shown in FIG. 5, a Database 501 contains repositories for Client businesses 502, Recipients 503, Content Directives 504, Schedules 505, and Additional Data 506.

Staff at Publishing Service 531 create a record in the Clients repository 502 for each Client 510, communicating with the database over WAN 530 and Web Hosting Service 520.

Clients 510 then use software 511 that they download over the WAN 512 and run on their own computers 513, to enter data into the Database 501 by way of WAN 512 and Web Hosting Service 520. These data consist of information for the Client's 510 own business and its Recipients 550, as well as Content Directives 504 and Schedules 505 for producing Personalized Newsletters 507.

Staff at the Publishing Service 531 also enter Content Directives 504 and Schedules 505 using software 535 downloaded over the WAN 530 from the Web Hosting Service 520. This software 535 may be identical to the software 511 used by the sending Clients, but with privileges available only to staff at the Publishing Service. Once the aforementioned is done, Personalized Newsletters 507 may be produced in a series of production runs over time.

For each production run of Personalized Newsletters 507, software running on Web Hosting Service 520 queries the Schedules 505 specified for each Client 502 and its Recipients 503 in the Database 501, as well as any default Schedules 505 specified in the Additional Data 506 for each Client's 502 vertical market, to determine which Primary Content Directive 504 should be guide the production of a Personalized Newsletter 507 for each Recipient 503 that is scheduled to receive one.

The instructions in each said Primary Content Directive 504 are processed by the content producer running on Web Hosting Service 520 to create personalized newsletters 507. This production process may draw on all information in the Database 501, including Nested Content Directives 504 as instructed by the Primary Content Directive 504.

Staff at the Publishing Service 531 review the Personalized Newsletters 507 using software 535 running on its computer 533, over the WAN 530. Once the Personalized Newsletters 507 have been approved, those that should be e-mailed to Recipients 550 are sent using software on the Web Hosting Service 520, and those that should be printed are downloaded over the WAN 530 to the Publishing Service 531, where they are sent to print 532 on a local printer 534 and mailed 541 the their Recipients 550.

Web Hosting Service 520 is shown as a single computer, but could be multiple computers joined in a LAN at the location of the Web Hosting Service 520.

Referring to FIG. 6, in the Newsletter Service Initialization Phase 620, the System Creator initializes 621 a database record for each Client with items including a user-name and password, and creates such additional data 622 as will be necessary to produce personalized newsletters. The System Creator then defines default Schedules 623 that will govern entire vertical markets the created Clients or both, and then creates Content Directives 624 that will be useful to one or more Clients.

Once a Client's record has been initialized 621, the Client may proceed with some initialization 610 on his own. Specifically, he will enter data for his Recipients 611, and create Schedules 612 for his newsletters. He can then create Content Directives 613 for Primary and Nested Content to send according to the Schedules he has defined 612.

The system is now ready to generate newsletters 630. The software will select Primary Content Directives per Recipient and per Defined Schedules 631 and then Produce Newsletter Content per said Primary Content Directives 632 (and their Nested Content Directives).

The Production/Distribution Phase 640 can now take place, with the newsletters being e-mailed or posted to their recipients.

The newsletters may serve the salespersons and their businesses in numerous important ways, including:
Such ultra-personalized newsletters provide information that is useful to each recipient. Because the articles are highly relevant and personal, and not just generic information about national trends, the recipient feels more appreciated and important. He is therefore more likely to give the salesperson repeat business or to provide a positive recommendation or referral to others about the salesperson, or to provide to the salesperson the names of leads that may be contacted.
Such ultra-personalized newsletters may include information to steer the Customer to the business's website, by mentioning contests, surveys and other features. This gives the salespersons opportunities to sell more products—theirs or someone else's.
Such ultra-personalized newsletters are useful to any business where referrals and Customer loyalty are important.
Such ultra-personalized newsletters offer businesses a cost-effective, ultra-personalized way to keep in touch with their Customers, win their loyalty, and get referrals.

The “personal touch” offered by this system and its newsletters allows businesses to tailor each newsletter to each recipient based on any criteria that the Client business wishes: demographics, purchasing information, time of year, length of time as a Customer, and so on, and to tailor each newsletter to any desired level, referring only to the Customer by name, referring to the Customer and his family members, referring to the Customer and his interests, including messages, ads, and stories that are selected according to the Customer's family data or personal interest, tailoring the Content of those ads and stories according to the Customer's family data or personal interests, and tailoring the Content of those ads and stories according to the data or personal interests of the Customer's family members or acquaintances.

Any number of possible newsletter layouts or other forms of communications is possible and anticipated within such a personalized messaging system. For example, the Client may be a periodical publisher and the system might be adapted to create monthly untraditionally-scheduled magazines in which articles could be selected and even their Content could be customized according to each subscriber's characteristics. As an example of this, an outdoors magazine could be constructed for one subscriber to only include fishing articles because that subscriber had indicated a preference for fishing and no interest in hunting, hiking, etc. And the magazine could be automatically sent to the subscriber's primary residence in most months and to a vacation residence in others. And each subscriber could have a differently scheduled subscription that was set to skip certain months when he was less inclined to do any reading or to be sent on some untraditional schedule, like every seventh week, because he did not read often enough to keep up with a monthly schedule. Even the specific type of fishing articles within this ultra-customized outdoor magazine could be selected according to subscriber preferences or demographics, such as including saltwater fishing and excluding bass fishing articles.

Even the article Content and advertisements within the magazine could be modified according to subscriber-specific criteria, as was done in the afore-described newsletters. Advertisers may be more attracted to place ads in such a publication knowing that their ads could be personalized to the reader with no added effort or expense to the magazine. A reader may be much more intrigued to investigate an advertised product when the ad mentions him or her by name or includes personally relevant information, and advertisers would certainly appreciate such an advantage over traditional blind advertising.

Even within the newsletter category, different layouts may be offered to, chosen by, or created by a sending business Client according to things such as their business goals or budget. Business Clients may dress up their newsletters with their own logos, banners from their websites, and photographs. The newsletters or publications may be printed in black and white, gray scale, full color, or combinations thereof. The type of paper on which they are printed may be a selectable option. To allow for delivery by postal mail, e-mail, or both, the newsletters are prepared in a suitable format, preferably HTML. FIGS. 1A, 2A, 3A, and 4A exemplify not only the simplicity of design, but the degree of customization that is possible.

Initially, multiple Content Directives that specify stock lay-outs may be created, programmed into the system, and offered to any given vertical market. For instance, auto dealerships may have choices of several standard newsletter layouts, financial advisers may have choices of several different newsletter layouts more appropriate for their typical goals, and magazines may have choices of several typical magazine layouts. These layouts may be prepared by the System Creators and pre-programmed into the system, based on advice obtained from businesses in the respective markets.

Once the business Client has selected the type of data that should be included for each type of Customer, the appropriate data-entry form, such as form 102, is created and programmed into the system. The business Client may then upload its existing Customer list or database into the system or may key the information in manually. The system provides an upload facility that can handle basic data in common formats such as comma-separated lists or popular database or spreadsheet formats.

However, business Clients' existing databases will not likely contain all of the ultra-personalization data that this system allows and anticipates, such as products previously purchased, birth dates of children, and photographs, to name just a few. The system therefore provides software with which the business Clients may enter that additional information, upload photographs, and perform other functions. The software may be automatically adjustable according to each Client's database schemas, needs, or goals, with set-up and varying fees possibly being required to cover special arrangements and any needed development.

Because keying-in all of the data or even keying-in just additional data after uploading is completed may be quite a project for a large Customer list, the system may offer a data-entry service, employing temporary, off-shore workers for each job. These workers may use the same program that is available to the Clients but be capable of doing all the data entry at a lower wage. Some Clients may elect to enter the ultra-personalization data on a day-forward basis only, and chip away at the backlog as they have time. The system allows for the creation of newsletters and such that function gracefully even in the absence of all the possible data.

Based on industry research, it is known that most potential Clients and Customers feel that “bigger” is not always better when it comes to newsletters. A multi-page tome is less likely to be read than a small but personalized and useful piece. In fact, postcards are being used very successfully within many vertical markets. In some embodiments, newsletters of the system may be provided on a single eight and one-half by eleven inch sheet that may be printed on both sides and folded as a self-mailer. This allows the Client to convey more useful information than the typical postcard, but may avoid intimidating the reader.

The system may provide an up-to-date library of articles designed for specific vertical markets and specific occasions. Each article may have sections that vary based upon specifics of the intended recipient, such as demographics, age, or interests. It should be appreciated that the possible variations may be much more sophisticated than simple mail-merges and information plug-ins. For example, recipients may be invited to complete an on-line survey and told that “we especially value feedback from long-time and local Customers like you, Bob,” right within invitation. That text would be automatically selected just because the Customer had purchased a certain minimum number of times and lived within a certain distance from the Client, but to the Customer, it would appear that the message had been personally typed with only him in mind. Had the Customer been a recent first-time purchaser, the message could say something like “we'd love to know whether we made a good first impression, Fred.”

For each vertical market, different articles may be made available. For example, each vertical market may be provided with, for example, fifty short articles from which to choose. The articles may be prepared by drawing on facts from trade publications and proven marketing principles advocated in such places as the National Automobile Dealers Association's website for auto dealerships, or from Realtor.org for real estate agencies. These articles may simply be used to get Clients started. Once underway, the System Creator may periodically poll its Clients for ideas, as well as continue with its own industry research, so that a robust pool of material is developed and maintained.

Clients may also be allowed to author articles for their use only. A Client-written article may be a personal note to just one Customer (“Thank you for visiting our office last week with your wife Karen, Jim.”), a notice to every Customer about a new service, or anything in between.

Initially, Clients may simply e-mail to the Creator the articles they want included, which are entered into the database for that Client. Alternatively or in addition, Clients may upload their own articles using a web-based facility.

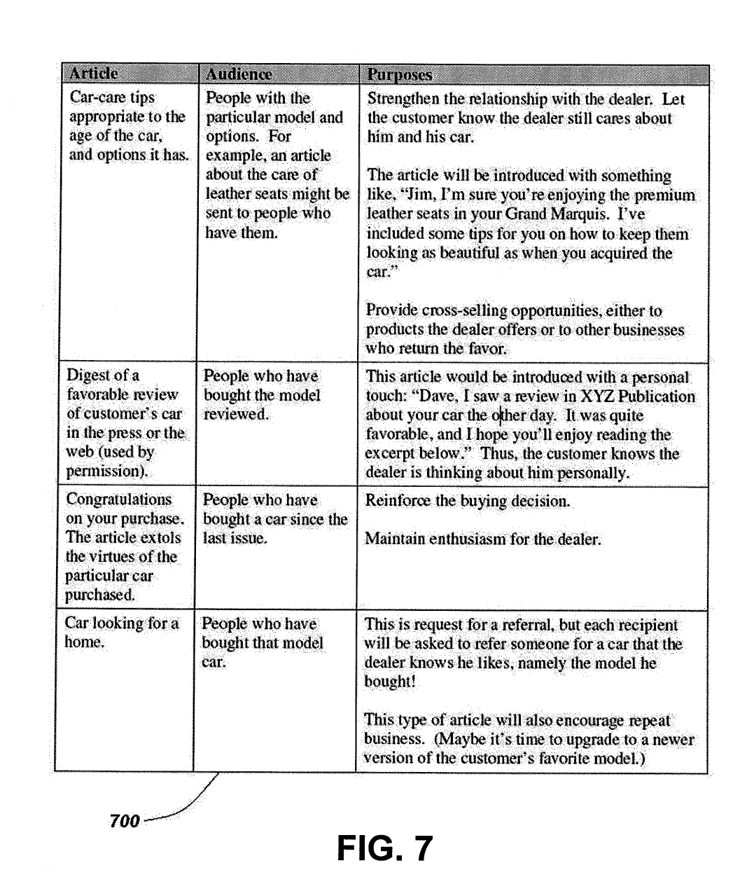

FIG. 7 provides an exemplary table 700 of typical articles that may be generated for use by automobile dealerships, showing the diversity of such possible articles, and the many purposes they may serve. Obviously, the library of articles may yield significant economies of scale compared to the Client attempting to write everything itself.

As previously mentioned, Clients may choose how often to send newsletters or publications, with the schedule being variable by recipient. For example, a new recipient might get a newsletter every three weeks for the first few months, and then go on a maintenance program of once every six weeks. Entry-level, pre-packaged campaigns can default to a twice-per-quarter schedule being delivered by postal mail. This particular schedule has actually been based on a compilation of feedback from Clients and provides a balance between frequency and frugality. Customers who want a different schedule are able to select it.

Beyond such an entry-level scheduling package, Clients may be offered e-mail facilities. Newsletters may be laid out in HTML so they are suitable for both print and e-mail distribution. E-mail is generally produced and delivered very inexpensively, so it may provide a better way to increase frequency without a substantial increase in cost. Yet although the simplicity and popularity of e-mail is ever-increasing, postal addresses are more readily available and a physical newsletter may be more durable and memorable than e-mail. In addition, Customers may be allowed to define their own scheduling and delivery method, using a program provided by the Creator to the Client and provided by the Client to the Customer in a format that hides the Creator's identity and gives the impression of creation by the Client.

In some embodiments, the production cycle may be regular, such as four times per month. The software may analyze the database at any desired frequency, selecting each and every recipient who is due to receive a newsletter, and creating a respective newsletter in HTML according to the recipient's respective personalization data.

In the case of e-mailed newsletters, the software may send the HTML-formatted newsletter directly to the recipient. Or the bulk of the newsletters may be printed and mailed directly from the Creator to the Customers in a format that leaves the impression of having come directly from the Client. The data files for all newsletters from a Client may be combined into one HTML file and transmitted to the Creator's printing facility.

Production of hardcopy newsletters may be accomplished using a color laser printer, a folding machine, and a large stack of high-quality paper. The printing may be done locally or transferred to one or more regional centers. Regional mailing centers may be used to send the newsletters by bulk mail via an appropriate Destination Bulk Mail Center. (See Section 246 of the USPS Domestic Mail Manual). Regional printing facilities may be established for low-overhead operations, perhaps providing employment for the handicapped in facilities they already have.

Among others, any vertical market that meets the following criteria could be an ideal candidate for using this system to communicate with its Customers;
Customer loyalty is important.
Referrals are important.
Developing a personal relationship with each Customer is important.
A Customer database is available or creatable.
There is a high average dollar volume per Customer per year.
Customers do not visit the business establishments regularly.
Customers are unique and likely to have individual purchasing practices.

It should be understood that a Content Directive is much more than a “fill-in the blank” document, a layout, or information from a database. It is a unified framework that can incorporate all those things and more.

Although the present system features different types of Content Directives, they're all the same in one key respect: each one directs that formatted data be passed to a “slot” (defined below) in the Content Directive above it, possibly after directing the gathering of parts of that formatted data from the Content Directives that plug into its slots. The result of the top-level Content Directive goes to the recipient via e-mail or print.

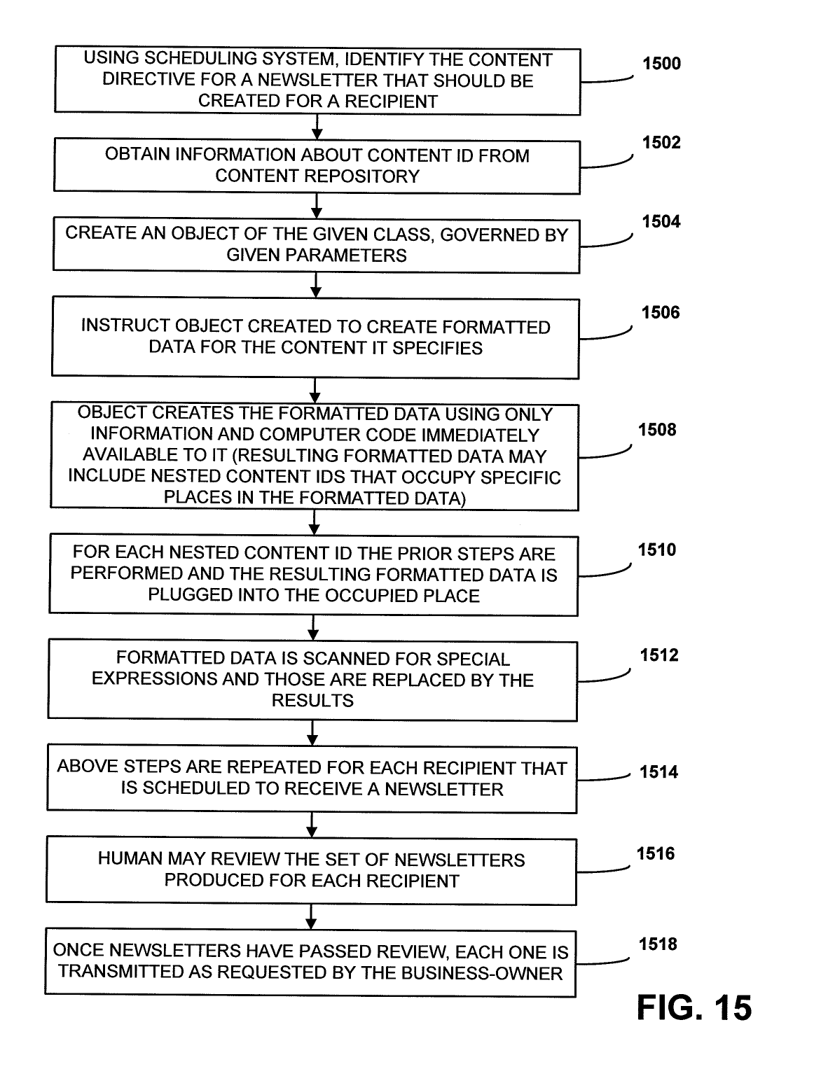

FIG. 15 is a flowchart illustrating steps performed to produce a newsletter within the system. Referring to FIG. 15, the following steps are taken by the system;
1. Using a scheduling system, identify the Content Directive for a newsletter, if any, that should be created for a recipient (block 1502). That Content Directive is uniquely identified by a Content ID.
2. Obtain information about that Content ID from the Content Repository (block 1504). The information will, at a minimum, contain a Content Provider ID and a parameter. The Content Provider ID specifies in general what “Class” of Content Provider can fulfill the instructions in the Content Directive.
3. Create an Object of the given Class, governed by the given parameter(s) (block 1506).
4. Instruct the Object created in step 3 to create formatted data for the Content it specifies (block 1508).
5. The Object from step 3 creates the formatted data using only information and computer code immediately available to it. The resulting formatted data may include nested Content IDs that occupy specific places in the formatted data (block 1510).
6. For each nested Content ID in step 5, steps 2 through this step 6 are performed and the resulting formatted data is plugged into the occupied place mentioned in step 5 (block 1512). Note that when this step 6 is performed on the nested data, Content IDs from the nested data may yet be present in the formatted data, and therefore another level of processing steps 2 through 6 will be performed. In computer parlance, this is called recursion.
7. After step 6 is performed to replace nested Content IDs with their actual Content, the formatted data is scanned for special expressions and those are replaced by their results (block 1514). For an example, an expression might multiply two numbers, which may be the data from different Content Directives, and be replaced by the result.
8. Steps 1 through 7 are repeated for each recipient that is scheduled to receive a newsletter.
9. A human may review the set of newsletters produced for each recipient by the preceding steps (block 1516).
10. Once the newsletters have passed review, each one is sent by e-mail, printed and mailed, or both, as requested by the business-owner (block 1518).

Content Directives can be fulfilled not only by Constant and Variable Content, but by other Content Directives as well (Nested Content Directives). Nested Content Directives may be indefinitely nested, in that the nesting can continue to any depth, constrained only by the physical limits of the computing device. Since everything from overall layout to the most trivial Constant Data is produced through the unifying concept of Content Directives, there is much more flexibility in what is produced.

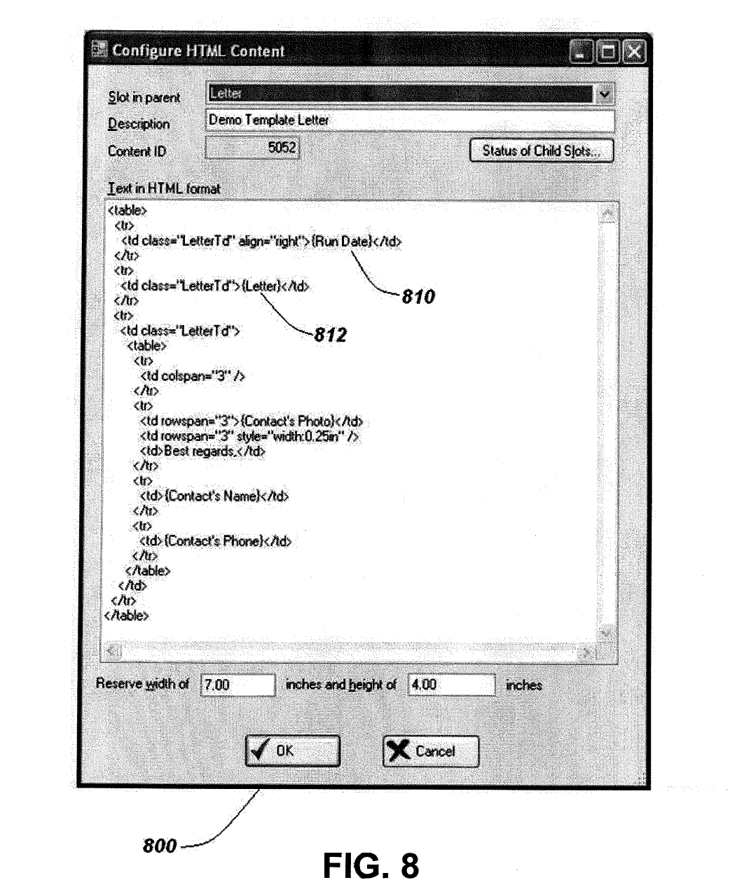

To produce the newsletter of FIG. 1B a Content Directive is first selected for the overall layout of the newsletter. This layout includes the envelope 104 and the main page 106, and requests Nested Content Directives for each. The Content Directive for the main page 106, in turn, requests a masthead 140, a letter portion (which includes date 142, salutation 144 and message 146), and two articles 150 and 152. These requests are made via Nested Content Directives. We shall now trace in detail the nesting of Content Directives for the letter portion. The letter layout is the subject of FIG. 8.

The Letter Layout Directive 800 shown in FIG. 8 uses HTML to specify, “Put the Run Date 810 in the upper right, put the body of the letter 812 below that, put the Contact's (salesperson's) Photo below that, insert the words, ‘Best regards’ next to the photo, and insert the Contact's Name and Phone Number under that constant text.” Note that this Directive includes both layout and text.

The Masthead 140 is specified in a simple Content Directive that obtains Variable Data (an image) from the Client database. The Masthead 140 hands this Variable Content back to the Layout Directive for placement on the page. However, the Masthead 140 could equally well obtain its Content by running a computer program that generates a different pretty picture each day. The Layout Directive would not care or even know.

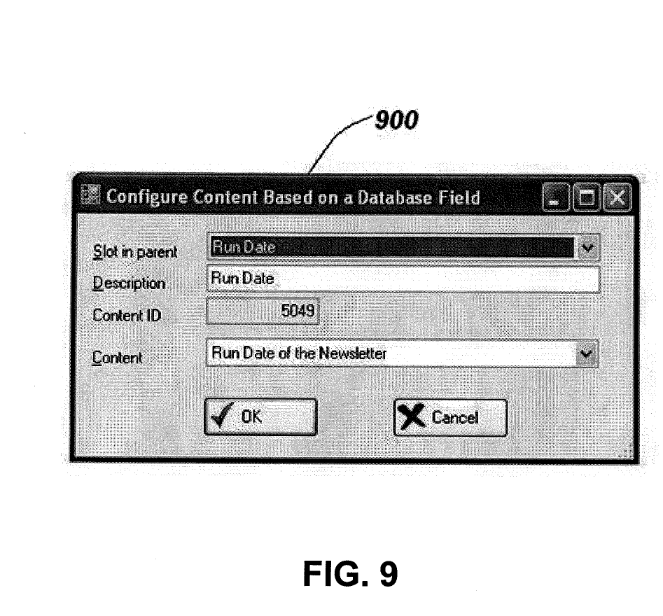

Returning to FIG. 8, the data within curly braces, such as “{Run Date}” 810, show where Nested Content is to be plugged in. FIG. 9 shows the configuration 900 of a Content Directive that supplies the Run Date. The rest of the layout is basic HTML. Although HTML is preferred for the layout, it is important to understand that the Content Directive is more than just HTML. The Content Directive can (and in this case does) contain non-HTML instructions to guide the content producer in producing the actual Content for the newsletter.

Content in the Letter Layout Directive 800 that expects to be fulfilled by Nested Content sets up “Slots” into which the Nested Content will be inserted by the applicable other Content Directives. For example, the Run Date slot 810 will be filled by a Content Directive 900 that yields the current date by a date Content Directive. A Contact's Name slot will be filled by a Content Directive that obtains the Customer's salesperson's name from the Customer's Content Directive.

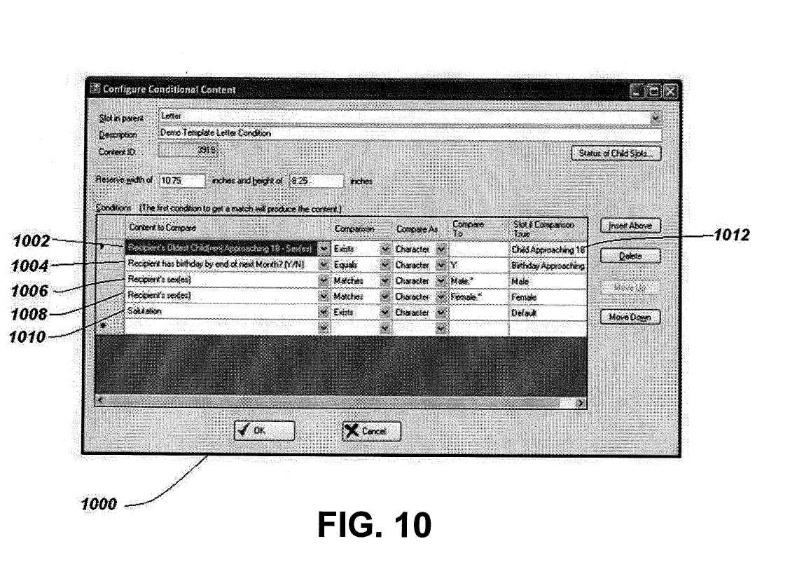

Letter Slot 812 is filled in this case by a Conditional Content Directive, the configuration of which is shown in FIG. 10. A Conditional Content Directive's sole function is to choose another Content Directive. In this case, the appropriate message is chosen by finding which of these conditions is true:
1. The Customer has a first child who will be eighteen years of age soon (1002),
2. The Customer's birthday will be by the end of next month (1004),
3. The Customer is male (1006),
4. The Customer is female (1008), and
5. The Customer has a salutation (1010)

Content will be chosen based on the first of those five conditions to be true. If no condition is true, default Content will be used.

Each of the five conditions (1002 to 1010) has a Content Directive of its own, but since the first condition 1002 is true and the Customer has a first child who will be eighteen years of age, the process moves from there. The first condition 1002 is another Content Directive, nested in slot “Child Approaching 18,” (1012) that is parameterized with layout instructions, Constant Content, and requests for additional Content Directives to complete the fulfillment.

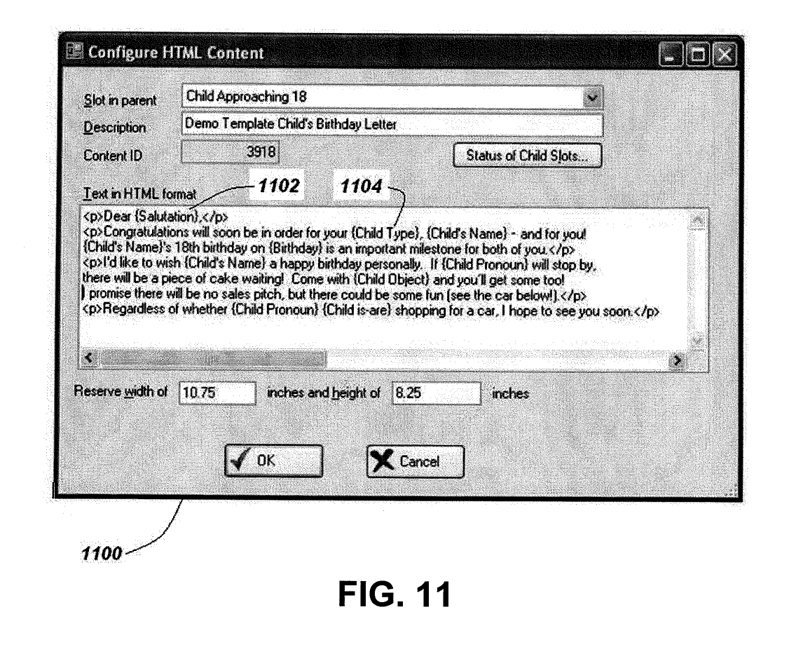

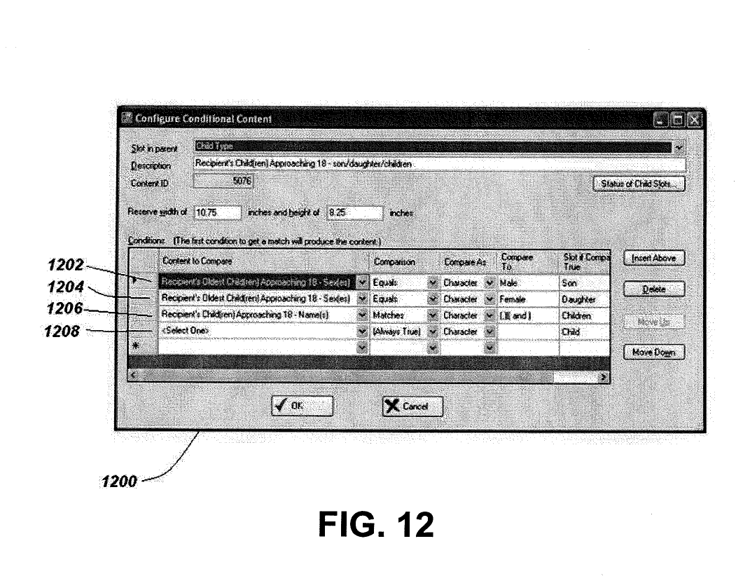

Referring next to FIG. 11, the Constant Content Directive 1100 for the first condition 1002 is shown. The Salutation 1102 is a Content Directive that obtains the recipient's salutation from the database. Child Type 1104 is another Conditional Content Directive that is configured as shown in FIG. 12.

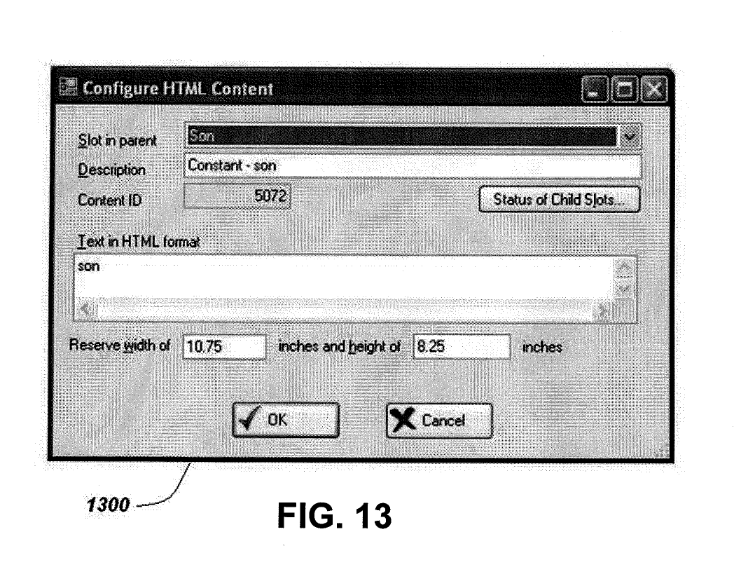

In the Child Type Content Directive 1200 of FIG. 12, it is seen that if the sex is “Male,” a slot 1202 is set up that is called “Son” that will be fulfilled with additional Content; if “Female,” Content will be taken from the “Daughter” slot 1204; if it contains a comma or the word “and” Content will be taken from the “Children” slot 1206; otherwise Content will be taken from the “Child” slot 1208. Each of the slots (Son 1202, Daughter 1204, Children 1206, and Child 1208) is fulfilled by a “Child Type” Content Directive that returns appropriate Constant Content, which is demonstrated in FIG. 13.

Considering the Nested Content Directives in FIGS. 10, 11, 12 and 13, one observes that because the Customer has one or more children approaching an eighteenth birthday, the chosen Content may contain any of the following:
“Congratulations will soon be in order for your son, Nathaniel . . . ”
“Congratulations will soon be in order for your daughter, Jane . . . ”
“Congratulations will soon be in order for your children, Nathaniel and Jane . . . ”
“Congratulations will soon be in order for your child, Timmy . . . ”

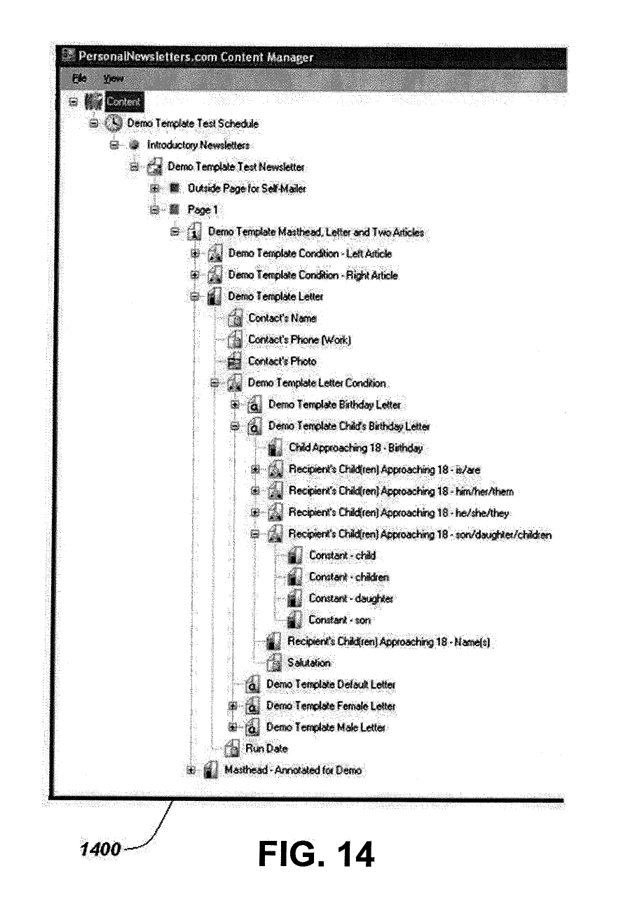

The above-mentioned follows just one branch of the Content Manager Process Tree 1400 shown in FIG. 14. Any node in the process tree 1400 that has a “plus sign” could be expanded to reveal its Nested Content.

As previously mentioned, the scheduling system allows each recipient to be on a different schedule, and will next be explained in more detail. The system may produce a run of newsletters, or any other type of communication, periodically, and may do so regularly, or on any arbitrary or irregular time frame.

For each run, every Customer for every Client is examined to see if a newsletter should be sent to him. To do this, a set of schedules is consulted. While it is preferred that the schedules are consulted in the following order, one having ordinary skill in the art will appreciate that a different order may be used.
1. The Customer's override schedule.
2. The Customer's normal schedule.
3. The Client's override schedule.
4. The Client's normal schedule.
5. The system Creator's override schedule for the Client's vertical market.
6. The system Creator's normal schedule for the Client's vertical market.

A “normal schedule” is the default schedule at that level. An “override schedule” can override the normal schedule on demand. Most of the time, the override schedules will not be used, as they are typically just for unusual situations such as a special promotion. In addition, most of the time, there will not be a special schedule for a particular Customer, but it can be appreciated that the system has much scheduling flexibility, and that different Customers may receive communications at different times.

The system moves down the list of schedules until it finds one that demands a newsletter for the current production run, and then a newsletter is produced that is on that schedule. A Customer does not receive two newsletters at once, because once a hit is made, the remaining schedules are not consulted. A new Customer may receive a newsletter frequently for the first few months, and may then shift to a “maintenance program” of less-frequent newsletters. Since Customers may be entered into the system at different times, there will be newsletter runs that result in mailings to some Customers, but not others.

Another type of schedule may involve an introductory phase with frequent newsletters, followed by a series of newsletters on specific dates. Newsletter runs would typically occur at regularly scheduled intervals, such as four times per month. At each run, each Customer is processed. For each Customer, an ordered list of schedules that may apply to the Customer, the Client, or the vertical market is examined. The first schedule that demands a newsletter on the current run date is chosen. If no such newsletter is found, the system continues to the next Customer. If such a newsletter is found, it is produced for that Customer.

Numerous features and aspects of the system warrant specific mention. For instance, the system does not select Content based on a scoring system of matching keywords in articles to the recipient's profile. Rather, it goes directly to the desired Content based on business rules. It selects one and only one result in the first place, so there is no need for “scoring.”

Although the Client may of course poll or take advice from its Customers, content preferences are primarily set by the Client, not the Customer. It is the Client that designs the marketing plan that results in certain Content being chosen for certain recipients. In addition, business rules are used to select Content, not a scoring based on interest value, and not any criteria that might be considered semi-quantitative.

There may be many different but overlapping Content repositories for different vertical markets. The Content Directives are neither hypertext nor hypermedia, and the formatting is generated throughout to the process, as the various Content Directives nest in each other, rather than being decided at the beginning or end.

There may be a Layout Content Directive at the top that is partly fulfilled by a letter, which in turn specifies both format and text, and so on, down to the lowest-level Content Directives that are fulfilled with either constant data or data from a database. Such top down formatting is done in nested fashion, with HTML (for example) governing the overall result at the end.

Almost all of the system's data will come from the system Creator's Content Repository, not from gathering data on the fly from Web pages. The system website address information will not be “user-defined” (i.e., defined by the Customer), but will rather be defined by a collaborative effort of the Client and System Creator, with the System Creator retrieving data based on commands that will be generated by the system's own program code, not anything user-defined.

Customers will not be in communication with the system's server, and Content can be shared between several Clients. In addition, printed publications may be produced using ordinary printers, such as a color laser printer.

In summary, the invention may include a method for facilitating the generation of highly personalized communications comprising the steps of:
1) Obtaining information related to a plurality of potential recipients and at least one sending business;
2) Automatically selecting at least one of the plurality of potential recipients according to a scheduling procedure individualized for each of the plurality; and
3) Providing to the selected at least one of the plurality of potential recipients a communication personalized individually therefore.

This method may further comprise the steps of:
4) Automatically selecting primary content instructions from a primary content repository for the selected at least one; and
5) automatically producing personalized content according to the primary content instructions.

This method may further comprise the steps of:
6) Automatically selecting secondary content instructions from a secondary content repository for the primary content instructions; and
7) Automatically further personalizing primary content according to the secondary content instructions.

In this method, the primary content instructions may be 1^{st} level content instructions and the primary content repository may be a 1^{st} level content repository, the secondary content instructions may be 2^{nd} level content instructions and the secondary content repository may be a 2^{nd} level content repository; and the method may further comprise the steps of:
8) Automatically selecting N^{th} level content instructions from an N^{th} level content repository for M^{th} level content instructions; and
9) Automatically further personalizing M^{th} level content according to the N^{th} level content instructions, where M is equal to N minus 1.

In this method, the step of automatically producing personalized content may comprise the use of additional data from one ore more additional repositories.

In this method, the one or more additional repositories may be taken from the group including a recipient repository, a business repository and an electronic repository.

In this method, the one or more additional repositories may comprise data uploaded from the at least one sending business.

In this method, the step of providing to the selected at least one may comprise one or more of emailing and posting by mail, according to a recipient preference.

In this method, one or more of mathematical and text-manipulation expressions in at least a portion of the personalized content may be evaluated by a content producer to create one or more related results, and the content producer may replace the at least a portion with the related results.

The invention may also include a system for generating highly personalized communications for at least one intended recipient comprising:
1) A primary content repository containing directives for producing content;
2) A schedule repository containing schedule information according to which the content should be produced; and
3) A content producer producing the content for the at least one intended recipient according to the directives and the schedule information.

In this system, the directives may be selected by the content producer according to schedules in the scheduling repository; and the content producer may produce personalized content according to primary content directives and may deliver the personalized content to the at least one intended recipient.

This system may further comprise a secondary content repository, wherein the personalized content is selected by the content producer from the secondary content repository for the primary content directives, and the personalized content is further personalized according to the secondary content directives.

This system may further comprise an N^{th} level content repository, wherein the primary content directives are 1^{st} level content directives and the primary content repository is a 1^{st} level content repository, and the secondary content directives are 2^{nd} level content directives and the secondary content repository is a 2^{nd} level content repository; and M^{th} level content is selected by the content producer according to N^{th} level content directives from the N^{th} level content repository; and the further personalized content is even further personalized according to the N^{th} level content directives, where M is equal to N minus 1.

In this system the personalized content may further comprise data taken from one ore more additional repositories.

In this system the one or more additional repositories may be taken from the group including a recipient repository, a business repository and an electronic repository.

In this system the one or more additional repositories may comprise data uploaded from the at least one sending business.

In this system the personalized content may be delivered to the at least one intended recipient by one or more of emailing and posting by mail, according to a recipient preference.

In this system the content producer may evaluate one or more of mathematical and text-manipulation expressions in at least a portion of the personalized content to create related results, and the content producer may replace the at least a portion with the related results.

The invention may also include a process for sending communications to recipients comprising the steps of:
1) Analyzing a scheduling criterion for each of a plurality of potential recipients;
2) Choosing each of the plurality of potential recipients whose scheduling criterion demands the receipt of a communication from a production period;
3) Producing one or more communications for the chosen each during the production period, and
4) Sending the one or more communications to the chosen each.

In this process, the analyzing may comprise examining an ordered list of schedules related to one or more of the each of a plurality of potential recipients, a sending business, and a vertical market in which the sending business operates.

This process may further comprise the step of altering the scheduling criterion of one or more of the plurality of potential recipients over time.

In this process, the scheduling criterion may have an inception date and the altering may occur at a selected time after the inception date and may cause a less frequent demand for receipt thereafter.

The invention may also include a process for creating personalized communications comprising the steps of:
1) Obtaining content information from the content repository, the content information comprising a content provider ID and one or more parameters, the content provider ID specifying a content directive class;
2) Creating an object according to the content directive class, the object defined by the one or more parameters, and the object specifying communication content;
3) Causing the object to create formatted data for the communication content, the formatted data comprising IDs for one or more of a constant content, variable content, and nested content; and
4) If the formatted data comprises nested content IDs, replacing the nested content IDs with actual content in the communication content and repeating this process through levels of nesting until no nested content IDs are present.

While the invention has been shown and described with reference to specific preferred embodiments, it should be understood by those skilled in the art that various changes in form and detail may be made therein without departing from the spirit and scope of the invention as defined by the following claims.

I claim:

1. A method for facilitating the generation of highly personalized communications comprising the steps of:
obtaining information related to a plurality of potential recipients and at least one sending business;
automatically selecting at least one of said plurality of potential recipients according to a scheduling procedure individualized for each of said plurality; and
providing to said selected at least one of said plurality of potential recipients a communication personalized individually therefore.

2. The method of claim 1 further comprising the steps of:
automatically selecting primary content instructions from a primary content repository for the selected at least one; and
automatically producing personalized content according to said primary content instructions.

3. The method of claim 2 further comprising the steps of:
automatically selecting secondary content instructions from a secondary content repository for said primary content instructions; and
automatically further personalizing primary content according to the secondary content instructions.

4. The method of claim 3 wherein:
said primary content instructions are 1^{st} level content instructions and said primary content repository is a 1^{st} level content repository;
said secondary content instructions are 2^{nd} level content instructions and said secondary content repository is a 2^{nd} level content repository; and
further comprising the steps of:
automatically selecting N^{th} level content instructions from an N^{th} level content repository for M^{th} level content instructions; and
automatically further personalizing M^{th} level content according to said N^{th} level content instructions,
where M is equal to N minus 1.

5. The method of claim 2 wherein said step of automatically producing personalized content comprises the use of additional data from one ore more additional repositories.

6. The method of claim 5 wherein said one or more additional repositories is taken from the group including a recipient repository, a business repository and an electronic repository.

7. The method of claim 5 wherein said one or more additional repositories comprises data uploaded from said at least one sending business.

8. The method of claim 2 wherein said step of providing to said selected at least one comprises one or more of emailing and posting by mail, according to a recipient preference.

9. The method of claim 4 wherein one or more of mathematical and text-manipulation expressions in at least a portion of said personalized content is evaluated by a content producer to create one or more related results, and said content producer replaces said at least a portion with said related results.

10. A system for generating highly personalized communications for at least one intended recipient comprising:
a primary content repository containing directives for producing content;
a schedule repository containing schedule information according to which said content should be produced; and
a content producer producing said content for the at least one intended recipient according to said directives and said schedule information.

11. The system of claim 10 wherein:
said directives are selected by said content producer according to schedules in said scheduling repository; and
said content producer produces personalized content according to primary content directives and delivers said personalized content to said at least one intended recipient.

12. The system of claim 11 further comprising a secondary content repository, wherein:
said personalized content is selected by said content producer from said secondary content repository for said primary content directives; and
said personalized content is further personalized according to said secondary content directives.

13. The system of claim 12 further comprising an N^{th} level content repository, and wherein:
said primary content directives are 1^{st} level content directives and said primary content repository is a 1^{st} level content repository; and
said secondary content directives are 2^{nd} level content directives and said secondary content repository is a 2^{nd} level content repository; and
M^{th} level content is selected by said content producer according to N^{th} level content directives from said N^{th} level content repository; and
said further personalized content is even further personalized according to said N^{th} level content directives, where M is equal to N minus 1.

14. The system of claim 11 wherein said personalized content further comprises data taken from one ore more additional repositories.

15. The system of claim 14 wherein said one or more additional repositories is taken from the group including a recipient repository, a business repository and an electronic repository.

16. The system of claim 14 wherein said one or more additional repositories comprises data uploaded from said at least one sending business.

17. The system of claim 11 wherein said personalized content is delivered to said at least one intended recipient by one or more of emailing and posting by mail, according to a recipient preference.

18. The system of claim 13 wherein said content producer evaluates one or more of mathematical and text-manipulation expressions in at least a portion of said personalized content to create related results, and said content producer replaces said at least a portion with said related results.

19. A process for sending communications to recipients comprising the steps of:
analyzing a scheduling criterion for each of a plurality of potential recipients;
choosing each of said plurality of potential recipients whose scheduling criterion demands the receipt of a communication from a production period;
producing one or more communications for said chosen each during said production period, and
sending said one or more communications to said chosen each.

20. The process of claim 19 wherein said analyzing comprises examining an ordered list of schedules related to one or more of said each of a plurality of potential recipients, a sending business, and a vertical market in which said sending business operates.

21. The process of claim 20 further comprising the step of altering said scheduling criterion of one or more of said plurality of potential recipients over time.

22. The process of claim 21 wherein said scheduling criterion has an inception date and said altering occurs at a selected time after said inception date and causes a less frequent demand for receipt thereafter.

23. A process for creating personalized communications comprising the steps of:
obtaining content information from the content repository, said content information comprising a content provider ID and one or more parameters, said content provider ID specifying a content directive class;
creating an object according to said content directive class, said object defined by said one or more parameters, and said object specifying communication content;
causing said object to create formatted data for said communication content, said formatted data comprising IDs for one or more of a constant content, variable content, and nested content; and
if said formatted data comprises nested content IDs, replacing said nested content IDs with actual content in said communication content and repeating this process through levels of nesting until no nested content IDs are present.
